(19) United States
(12) Patent Application Publication
(10) Pub. No.: US 2009/0267966 A1
(43) Pub. Date: Oct. 29, 2009

(54) PLASMA DISPLAY APPARATUS

(75) Inventors: Youngjoon Ahn, Gyoungsangbuk-do (KR); Sungyong Ahn, Gyoungsangbuk-do (KR); Wonsik Yoon, Gyoungsangbuk-do (KR); Soomyun Lee, Gyoungsangbuk-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/295,301

(22) PCT Filed: Dec. 13, 2007
(86) PCT No.: PCT/KR07/06516

§ 371 Date: Sep. 30, 2008

(30) Foreign Application Priority Data
Dec. 14, 2006 (KR) 10-2006-0127684

(51) Int. Cl. G09G 5/10

(52) U.S. Cl. 345/690; 345/72

(57) ABSTRACT

A plasma display apparatus that can reduce a manufacturing cost even while embodying a screen ratio of 16:9 by adjusting the number of the third electrode formed in the rear substrate is provided. The plasma display apparatus comprises: a plasma display panel comprising an electrode; and a driver for supplying a driving signal to the electrode, the plasma display panel comprises: a front substrate; a rear substrate opposite to the front substrate; a barrier rib for partitioning a discharge cell between the front substrate and the rear substrate; first electrodes and second electrodes opposite to each other in the discharge cell; and third electrodes intersecting the first electrodes in the discharge cell, wherein the number of the third electrodes is 4095 in an active area in which an image is displayed, and the driver comprises a plurality of data drivers comprising channels connected to the third electrode, and 256 channels are formed in each of the data drivers.

### TECHNICAL FIELD

This document relates to a plasma display apparatus.

### BACKGROUND ART

A plasma display apparatus comprises a plasma display panel in which an electrode is formed and a driver for supplying a driving signal to the electrode of the plasma display panel.

In general, the plasma display panel comprises a discharge cell partitioned by barrier ribs, and a phosphor layer is formed within each discharge cell. The driver supplies a driving signal to a discharge cell through the electrode.

Accordingly, a discharge is generated by the supplied driving signal within the discharge cell. When a discharge is generated by the driving signal within the discharge cell, a discharge gas filled within the discharge cell generates light such as ultraviolet rays, and light such as ultraviolet rays enables a phosphor formed within the discharge cell to emit light, thereby generating visible light. By the visible light, an image is displayed on a screen of the plasma display panel.

The driver is connected to an electrode formed in the plasma display panel through a data driver. As in an address electrode, an electrode to which a signal is selectively applied is connected to the data driver in which a switching element is formed.

### DISCLOSURE OF INVENTION

### Technical Problem

Because a data driver comprises a switching element, a component of the data driver is expensive. Therefore, when many data drivers use, a manufacturing cost of the plasma display apparatus increases.

### Technical Solution

An aspect of this document is to provide a plasma display apparatus that can reduce a manufacturing cost even while embodying a screen ratio of 16:9 by adjusting the number of third electrodes formed in a rear substrate.

In one general aspect, a plasma display apparatus comprises: a plasma display panel comprising an electrode; and a driver for supplying a driving signal to the electrode, the plasma display panel comprises: a front substrate; a rear substrate opposite to the front substrate; a barrier rib for partitioning a discharge cell between the front substrate and the rear substrate; first electrodes and second electrodes opposite to each other in the discharge cell; and third electrodes intersecting the first electrodes in the discharge cell, wherein the number of the third electrodes is 4095 in an active area in which an image is displayed, the driver comprises a plurality of data drivers comprising channels connected to the third electrodes, and 256 channels are formed in each of the data drivers.

The total number of the data driver may be 16.

The discharge cell may comprise a red color discharge cell, a green color discharge cell, and a blue color discharge cell, and the number of each of the red color discharge cell, the green color discharge cell, and the blue color discharge cell may be 1365.

The total number of the first electrodes may be 768.

A dummy area may be disposed at the outer side of the active area, and a part of the third electrode may be disposed in the dummy area.

The third electrode disposed in the dummy area may not be connected to the channel.

The data driver may comprise: a data driver integrated circuit for supplying a data signal to the third electrode with a switching operation; and a flexible substrate in which the data driver integrated circuit is arrived and in which the channel is formed.

In another aspect, a plasma display apparatus comprises: a plasma display panel comprising an electrode; and a driver for supplying a driving signal to the electrode, the plasma display panel comprises: a front substrate; a rear substrate opposite to the front substrate; a barrier rib for partitioning a discharge cell between the front substrate and the rear substrate; first electrodes and second electrodes opposite to each other in the discharge cell; and third electrodes intersecting the first electrodes in the discharge cell, wherein the number of the third electrodes is 4095 in an active area in which an image is displayed, the driver comprises a plurality of data drivers comprising channels connected to the third electrodes, and the data driver comprises a first data driver in which 192 channels are formed and a second data driver in which 256 channels are formed.

### ADVANTAGEOUS EFFECTS

In a plasma display apparatus in an implementation of this document, a manufacturing cost can be reduced even while embodying a screen of a WXGA level having a screen ratio of 16:9 by using a data driver comprising 4095 third electrodes and 256 channels.

### BRIEF DESCRIPTION OF THE DRAWINGS

FIG. 1 is a block diagram illustrating a configuration of a plasma display apparatus in an implementation of this document;

FIG. 2 is a perspective view illustrating a shape in which a plasma display panel and a data driver are coupled;

FIG. 3 is a cross-sectional view taken along line III-III of FIG. 2;

FIG. 4 is an exploded perspective view illustrating a plasma display panel to be comprised in a plasma display apparatus in an implementation of this document;

FIG. 5 is a diagram illustrating electrode arrangement of the plasma display panel shown in FIG. 4;

FIG. 6 is a plan view illustrating a connection relationship between a third electrode and a channel;

FIG. 7 is a diagram illustrating a connection state of a data driver comprising the third electrode and 256 channels;

FIG. 8 is a diagram illustrating a connection relationship between the third electrode and the channel in another implementation of this document; and

FIG. 9 is a diagram illustrating an image frame for expressing a gray level of an image in a plasma display apparatus in an implementation of this document.

### BEST MODE FOR CARRYING OUT THE INVENTION

Hereinafter, a plasma display panel in an implementation of this document is described in detail with reference to the attached drawings.

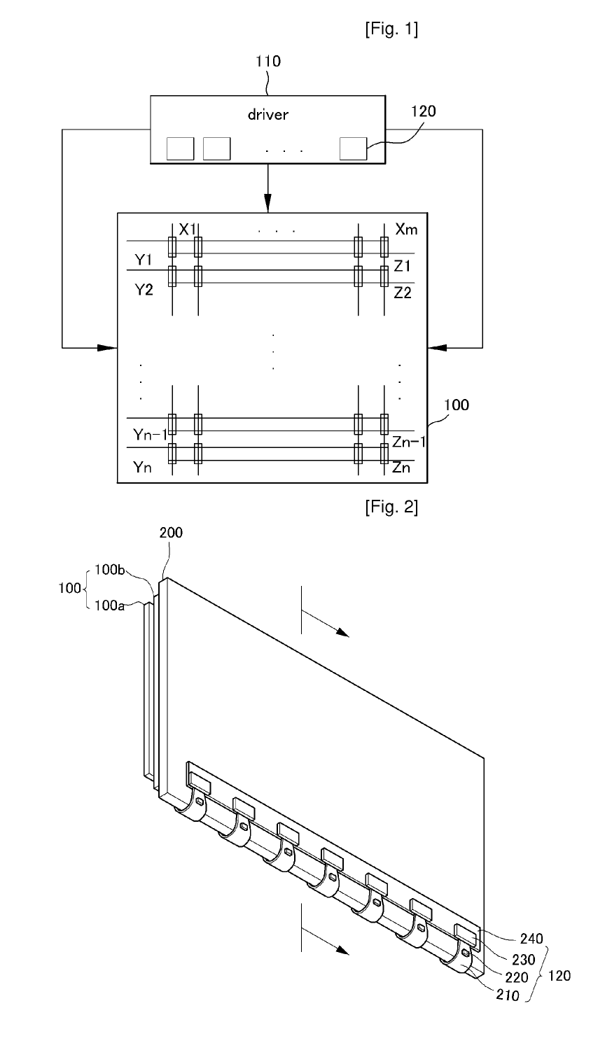

FIG. 1 is a block diagram illustrating a configuration of a plasma display apparatus in an implementation of this document.

Referring to FIG. 1, the plasma display apparatus comprises a plasma display panel 100 and a driver 110.

The plasma display panel 100 comprises an electrode. For example, the plasma display panel 100 comprises first electrodes (Y1 to Yn) and second electrodes (Z1 to Zn) in parallel to each other and third electrodes (X1 to Xm) intersecting the first electrodes (Y1 to Yn) and the second electrodes (Z1 to Zn).

The driver 110 supplies a driving signal to an electrode of the plasma display panel 100. The driver 110 further comprises a plurality of data drivers 120 for applying a driving signal to the third electrodes (X1 to Xm), and the data driver 120 comprises a channel electrically connected to each of the third electrodes (X1 to Xm).

FIG. 1 illustrates only a case in which the driver 110 consists of one board, however in this document, the driver 110 may be divided into a plurality boards according to an electrode formed in the plasma display panel 100.

For example, the driver 110 may be divided into a first driver (not shown) for driving the first electrodes (Y1 to Yn) of the plasma display panel 100, a second driver for driving the second electrodes (Z1 to Zn), and a third driver (not shown) for driving the third electrodes (X1 to Xm). The third driver may comprise a data driver 120.

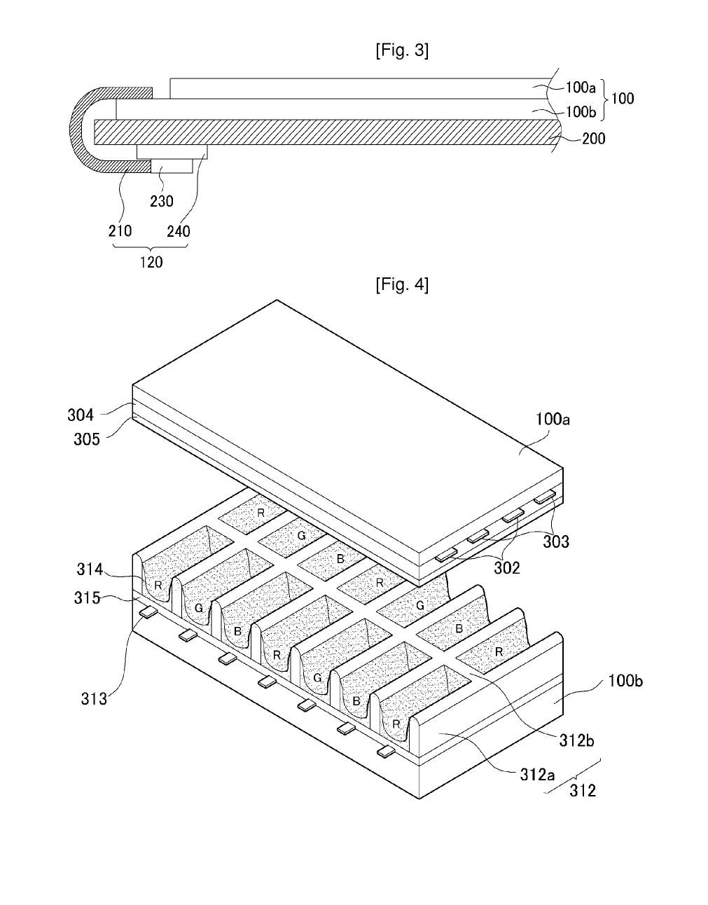

FIG. 2 is a perspective view illustrating a shape in which a plasma display panel and a data driver are coupled, and FIG. 3 is a cross-sectional view taken along line III-III of FIG. 2.

First, referring to FIG. 2, the data driver 120 comprises a data driver integrated circuit 220 for supplying a data signal to the third electrode of the plasma display panel 100 with a switching operation and a flexible substrate 210 in which the data driver integrated circuit 220 is arrived and in which a channel (not shown) is formed. Further, the data driver 120 may further comprise a connector 230 and a driving board 240.

The data driver 120 can be disposed on a rear surface or a side surface of a frame 200 disposed on a rear surface of the plasma display panel 100.

The flexible substrate 210 connects the data driver 120 and the third electrode of the plasma display panel 100, and a channel (not shown) formed in the flexible substrate 210 is connected to each of the third electrodes. The flexible substrate 210 is connected to the driving board 240 through the connector 230.

Although not shown, various signals in which other driving devices disposed on a rear surface of the frame 200 supply can be supplied to the data driver integrated circuit 220 disposed at the flexible substrate 210, and thus the data driver integrated circuit 220 can supply a data signal to the third electrode with a switching operation.

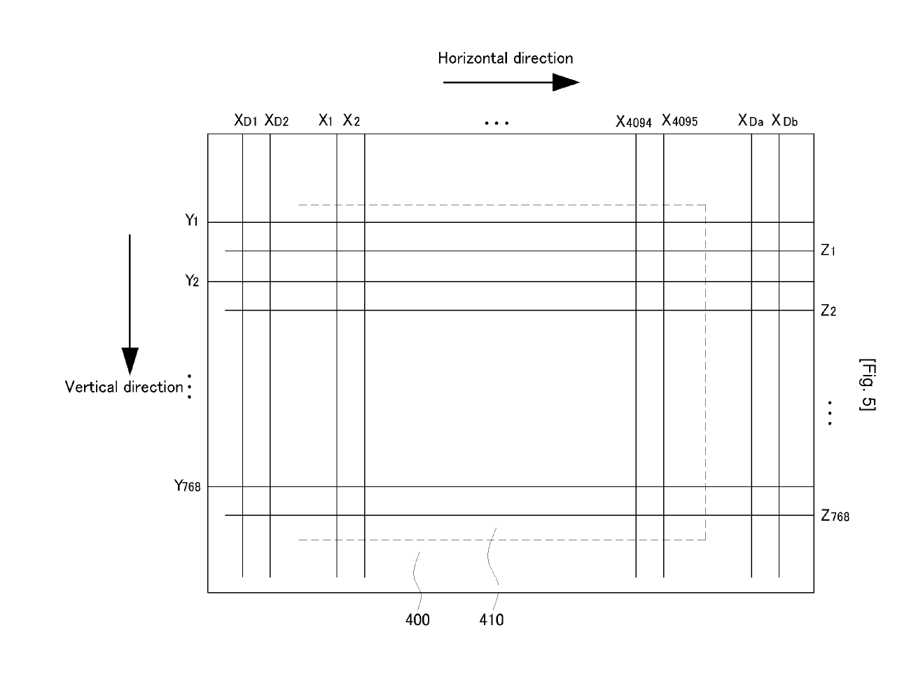

FIG. 4 is an exploded perspective view illustrating a plasma display panel to be comprised in a plasma display apparatus in an implementation of this document.

Referring to FIG. 4, the plasma display panel is formed by cohering a front substrate 100a in which a first electrode 302 (Y) and a second electrode 303 (Z) in parallel to each other are formed and a rear substrate 100b in which a third electrode 313 (X) intersecting the first electrode 302 and the second electrode 303 is formed. The first electrode 302 and the second electrode 303 are parallel to each other with a discharge cell interposed therebetween, and the first electrode 302 can be operated to select a discharge cell to be turned on by operating with the third electrode 313.

In the front substrate 100a in which the first electrode 302 and the second electrode 303 are formed, a dielectric layer, for example an upper dielectric layer 304 can be formed to cover the first electrode 302 and the second electrode 303.

The upper dielectric layer 304 limits a discharge current of the first electrode 302 and the second electrode 303 and insulates the first electrode 302 and the second electrode 303 from each other.

A protective layer 305 for facilitating a discharge condition can be formed on the front substrate 100a in which the upper dielectric layer 304 is formed. The protective layer 305 may comprise a magnesium oxide (MgO) material.

A third electrode 313 intersecting an electrode, for example the first electrode 302 in a discharge cell is formed on the rear substrate 100b, and a lower dielectric layer 315 for covering the third electrode 313 is formed in an upper part of the rear substrate 100b in which the third electrode 313 is formed.

The lower dielectric layer 315 can insulate the third electrode 313.

In an upper part of the lower dielectric layer 315, a barrier rib 312 of a stripe type, a well type, a delta type, and a hive type for partitioning a discharge space, i.e. a discharge cell is formed. FIG. 4 shows an example in which a discharge cell is formed in a closed type by a second barrier rib 312a formed in the same direction as the third electrode 313 and a first barrier rib 312b formed in the same direction as the first electrode 302 or the second electrode 303. A phosphor layer 314 is further formed in a discharge cell formed in this way. According to a light emitting color of a phosphor, each discharge cell can be divided into a red color (R) discharge cell, a blue color (B) discharge cell, and a green color (G) discharge cell.

A width of the red color (R) discharge cell as an example of the discharge cell may be smallest, and widths of the green color (G) discharge cell and the blue color (B) discharge cell may become greater than a width of the red color (R) discharge cell.

A width of the green color (G) discharge cell may be substantially equal to or different from that of the blue color (B) discharge cell.

Further, a thickness of the phosphor layer 314 in at least one of the red color (R) discharge cell, the green color (G) discharge cell, and the blue color (B) discharge cell may be different from that of the phosphor layer 314 of other discharge cells. For example, a thickness of the blue color (B) phosphor layer may be thicker than a thickness of a phosphor layer in the red color (R) discharge cell, i.e. a red color (R) phosphor layer. A thickness of the green color (G) phosphor layer may be substantially equal to or different from that of the blue color (B) phosphor layer. Accordingly, a color temperature characteristic of an embodied image can be improved.

A predetermined discharge gas is filled within the discharge cell partitioned by the barrier ribs 312. Further, within the discharge cell partitioned by the barrier ribs 312, when an address discharge is performed, a phosphor layer 314 for emitting visible light for displaying an image can be formed. For example, a red color (R) phosphor layer, a green color (G) phosphor layer, and a blue color (B) phosphor layer can be formed.

In the above-described description, only an example of a plasma display panel that can be applied to a plasma display apparatus in an implementation of this document is described, however this document is not limited to the plasma display panel having the above-described structure. For example, the third electrode 313 formed on the rear substrate 100b may be substantially constant in a width or a thickness, however a width or a thickness within a discharge cell may be different from that outside the discharge cell. For example, a width or a thickness within a discharge cell may be wider or thicker than that outside the discharge cell.

FIG. 5 is a diagram illustrating electrode arrangement of the plasma display panel shown in FIG. 4.

Referring to FIG. 5, the plasma display panel comprises an active area 410 in which an image is displayed and a dummy area 400 that does not contribute to the display of an image. The active area 410 is an area for displaying an image by generating predetermined visible rays upon driven and a structure thereof is described in detail in FIG. 4. The number of the third electrodes (X₁ to X₄₀₉₅) formed in the active area 410 is 4095.

It is assumed that a discharge cell formed between the front substrate (not shown) and the rear substrate (not shown) comprises a red color discharge cell, a green color discharge cell, and a blue color discharge cell. In this case, in a structure in which one third electrode passes through one discharge cell, the number of each of the red color discharge cell, the green color discharge cell, and the blue color discharge cell is 1365. Accordingly, the number of pixels disposed in a horizontal direction in the active area 410, i.e. an arrangement direction of the third electrode is 1365, and the number of the discharge cells is 1365×3.

Further, the number of at least one of the first electrodes (Y₁ to Y₇₆₈) and the second electrodes (Z₁ to Z₇₆₈) formed in the active area 410 is 768. Accordingly, the number of pixels disposed in a vertical direction in the active area 410 i.e. in an arrangement direction of the first electrode or the second electrode is 768.

Accordingly, the plasma display apparatus in an implementation of this document may have resolution of 1365×768 and a screen of a Wide Extended Graphics Array (WXGA) level that embodies a screen ratio of 16:9.

A dummy area 400 can be disposed at the outer side of the active area 410. The dummy area 400 can be formed to secure structural stability of the active area 410 or to secure operation stability in the active area 410.

The third electrodes (X_{D1} to X_{Db}) can be disposed even in the dummy area 400. Because the dummy area 400 does not contribute to the display of an image, it is unnecessary to supply a data signal to the dummy area 400. Accordingly, the third electrodes (X_{D1} to X_{Db}) disposed in the dummy area 400 may not be connected to a channel.

FIG. 5 shows that the first electrode and the second electrode are formed only in the active area 410, however at least one of the first electrode and second electrode can be formed even in the dummy area 400.

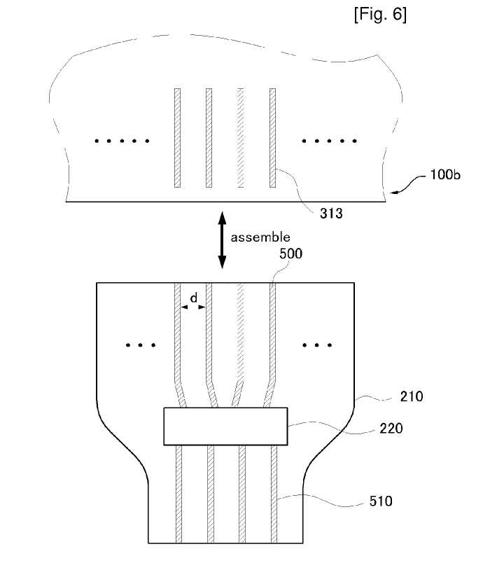

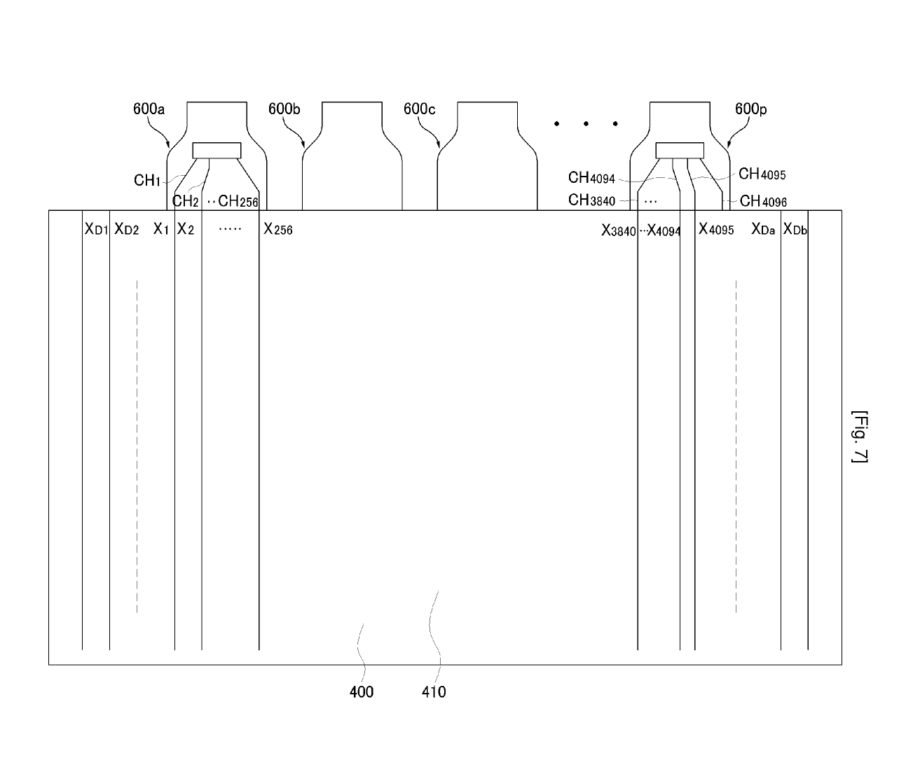

FIG. 6 is a plan view illustrating a connection relationship between a third electrode and a channel.

Referring to FIG. 6, a data driver comprises a flexible substrate 210 and a data driver integrated circuit 220 disposed at the flexible substrate 210.

Channels 500 can be formed in the flexible substrate 210. As the flexible substrate 210 is attached to the rear substrate 100b, the third electrode 313 and the channel 500 of the flexible substrate 210 can be electrically connected. Accordingly, the data driver integrated circuit 220 and the third electrode 313 can be electrically connected through the channel 500.

When the flexible substrate 210 is attached to the rear substrate 100b, the flexible substrate 210 can be attached to the rear substrate 100b using anisotropic conductive film.

The channels 500 can be disposed with an interval ‘d’ therebetween in the flexible substrate 210. Further, in the flexible substrate 210, a transmission line 510 for electrically connecting the driving board 240 described in FIGS. 2 and 3 and the data driver integrated circuit 220 can be formed.

The number of the channels 500 provided in one data driver is 256. For example, the number of the channels 500 formed in one flexible substrate 210 may be 256.

Accordingly, when it is assumed that one data driver integrated circuit 220 is disposed at one flexible substrate 210, the output of one data driver integrated circuit 220 may be also 256.

FIG. 6 shows only a case where one data driver integrated circuit 220 is disposed at one flexible substrate 210, however a plurality of data driver integrated circuits 220 may be disposed at the one flexible substrate 210.

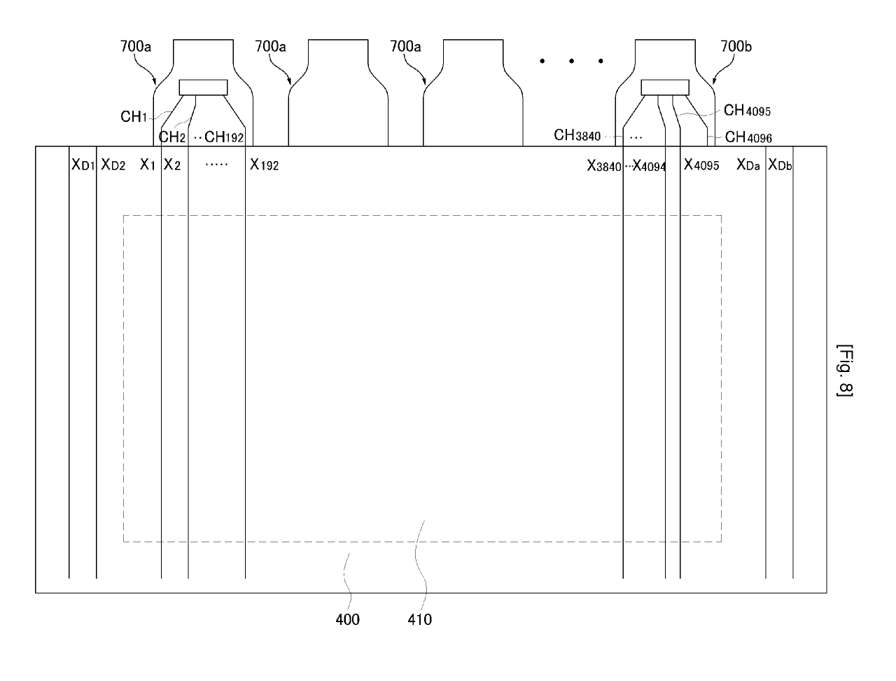

FIG. 7 is a diagram illustrating a connection state of a data driver comprising the third electrode and 256 channels.

Referring to FIG. 7, total 16 data drivers (600a to 600p) are required to supply a data signal to 4095 third electrodes formed in an active area 410 of a plasma display panel applied to an implementation of this document.

Because each of the data drivers (600a to 600p) comprises 256 channels, the number of channels comprising total 16 data drivers (600a to 600p) is 256×16=4096.

Therefore, the 16 data drivers (600a to 600p) can supply a data signal to 4095 third electrodes formed in an active area of the plasma display panel.

For example, the first data driver 600a comprises the first channel (CH 1) to the 256 channels (CH 256), and each of the first channel (CH 1) to the 256th channel (CH 256) is connected to the first third electrode X₁ to the 256th third electrode X₂₅₆.

In this way, the 16th data driver 600p comprises the 3840th channel (CH 3840) to the 4096th channel (CH 4096), and each of the 3840th channel (CH 3840) to the 4095th channel (CH 4095) is connected to the 3840th third electrode (X₃₈₄₀) to the 4095th third electrode (X₄₀₉₅). Further, a final channel i.e. the 4096th channel (CH 4096) of the 16th data driver (600p) may not be connected to the third electrode. For example, the 4096th channel (CH 4096) may be in a floating state.

For comparing with this, it is assumed that one data driver comprises 192 channels.

In this case, 22 data drivers are required to use resolution of 1366×768 to embody a screen of a WXGA level having a screen ratio of 16:9.

In more detail, in a plasma display panel for embodying resolution of 1366×768, the number of the third electrodes is 4098 in an active area and the number of at least one of the first electrode and the second electrode is 768. When the number of data drivers comprising 192 channels is 21, the number of total channels is 192×21=4032 and thus the number of the channels is insufficient. Therefore, at least 22 data drivers are required. In this case, the number of total channels is 192×22=4224 and thus the number of unnecessary channels is 4224−(1366×3), i.e. 4224−4098=126. Accordingly, because 126 channels are wasted, a manufacturing cost increases.

Further, when one data driver comprises 192 channels, when resolution of 1365×768 is used to embody a screen of a WXGA level having a screen ratio of 16:9, total 22 data drivers are required.

In this case, the number of total channels is 192×22=4224, and thus the number of unnecessary channels is 4224−1365×3, i.e. 4224−4095=129. Accordingly, because 129 channels are wasted, a manufacturing cost increases.

Further, it is assumed that one data driver comprises 256 channels.

In this case, in order to embody a screen of a WXGA level having a screen ratio of 16:9, 17 data drivers are required to use resolution of 1366×768.

In this case, the number of total channels is 256×17=4352, and thus the number of unnecessary channels is 4352−(1366×3) i.e. 4352−4098=254. Accordingly, because 254 channels are wasted, a manufacturing cost increases.

Further, in this case, in a process of connecting a channel of a data driver and a third electrode, workability may be deteriorated. Accordingly, an inferiority rate increases, and thus a manufacturing cost may increase.

As in an implementation of this document, when resolution of 1365×768 is used to embody a screen of a WXGA level having a screen ratio of 16:9, it is sufficient to use 16 data drivers. In order words, if the number of the third electrodes is set to 4095, only 16 data drivers are required to embody a screen of a WXGA level having a screen ratio of 16:9.

In more detail, in this case, the number of total channels is 256×16=4096 and thus the number of unnecessary channels is 4096−(1365×3) i.e. 4096−4095=1. Further, in this case, a data driver fewer by one data driver than when resolution of 1366×768 is used to embody a screen having a WXGA level of a screen ratio of 16:9 using a data driver of 256 channels can be used.

Accordingly, even while embodying a screen of a WXGA level having a screen ratio of 16:9, a manufacturing cost can be lowered. Further, in this case, an interval between channels can be fully widely secured, as in the interval ‘d’ of FIG. 6. Accordingly, in a process of connecting a channel of a data driver and the third electrode, workability can be improved and an inferiority rate can be lowered. In the above-described implementation, a plasma display panel having resolution of 1365×768 using a data driver comprising 256 channels is described.

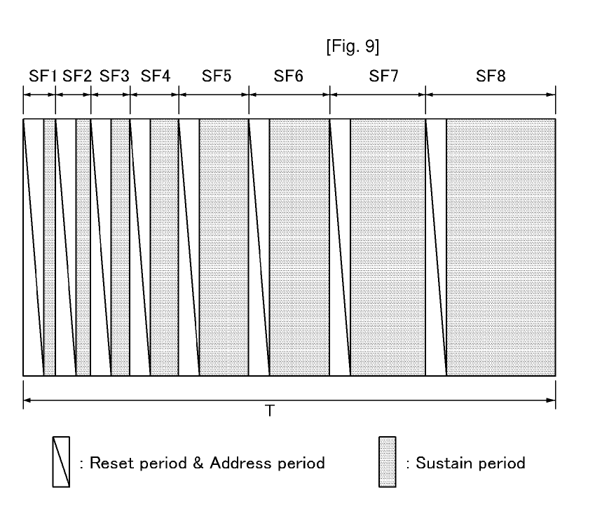

Referring to FIG. 8, a plasma display panel in another implementation of this document is described. When compared with the above-described implementation, both implementations are the same in having resolution of 1365×768, however are different in a configuration of a data driver. This is described in detail.

In another implementation of this document, the data driver comprises a first data driver 700a in which 192 channels are formed and a second data driver 700b in which 256 channels are formed.

In the active area 410, because the number of the third electrode is 1365×3=4095, total 4095 channels are required. Accordingly, when 20 first data drivers 700a comprising 192 channels and one second data driver 700b comprising 256 channels are used, the number of the total channels is {192×20)+(256×1)} i.e. 4096. Therefore, while losing 1 channel, all third electrodes comprised in the active area can be connected.

When compared with this, if the plasma display panel has resolution of 1366×768, the number of total channels is 1366×3 i.e. 4098 in the active area. Therefore, if a data driver comprising 192 channels is used, when the number of the data drivers is 21, the number of total channels is 192×21 i.e. 4032. Therefore, because 66 channels are insufficient, total 22 data drivers are required, whereby 126 (=192−66) channels are wasted at the 22nd data driver.

In FIG. 8, the second data driver 700b is disposed at a final location, however the second data driver 700b may be disposed anywhere. For example, the second data driver 700b may be disposed at the first location or between the first data drivers 700a.

FIG. 9 is a diagram illustrating an image frame for embodying a gray level of an image in a plasma display apparatus in an implementation of this document.

Referring to FIG. 9, in the plasma display apparatus, an image frame for embodying a gray level of an image can be divided into a plurality of subfields.

At least one of a plurality of subfields can be divided into a reset period for initializing a discharge cell, an address period for selecting a discharge cell to be discharged, and a sustain period for embodying a gray level.

By adjusting the number of sustain signals supplied in a sustain period, a gray level weight of the corresponding subfield can be set. That is, a predetermined gray level weight can be given to each subfield using a sustain period. For example, a gray level weight of each subfield can be determined so that a gray level weight of each subfield increases with a ratio of 2ⁿ (n=0, 1, 2, 3, 4, 5, 6, 7) using a method of setting a gray level weight of the first subfield to 2⁰ and a gray level weight of the second subfield to 2¹. By adjusting the number of sustain signals supplied in a sustain period of each subfield according to a gray level weight in each subfield, a gray level of various images can be embodied.

Further, in FIG. 9, subfields are arranged in an increasing order of a gray level weight in one image frame, however subfields may be arranged in an decreasing order of a gray level weight in one image frame.

1. A plasma display apparatus comprising:
a plasma display panel comprising an electrode; and
a driver for supplying a driving signal to the electrode,
the plasma display panel comprises:
a front substrate;
a rear substrate opposite to the front substrate;
a barrier rib for partitioning a discharge cell between the front substrate and the rear substrate;
first electrodes and second electrodes opposite to each other in the discharge cell; and
third electrodes intersecting the first electrodes in the discharge cell,
wherein the number of the third electrodes is 4095 in an active area in which an image is displayed,
the driver comprises a plurality of data drivers comprising channels connected to the third electrodes, and
256 channels are formed in each of the data drivers.

2. The plasma display apparatus of claim 1, wherein the total number of the data drivers is 16.

3. The plasma display apparatus of claim 1, wherein the discharge cell comprise a red color discharge cell, a green color discharge cell, and a blue color discharge cell, and
the number of each of the red color discharge cell, the green color discharge cell, and the blue color discharge cell is 1365.

4. The plasma display apparatus of claim 1, wherein the total number of the first electrodes is 768.

5. The plasma display apparatus of claim 1, wherein a dummy area is disposed at the outer side of the active area, and the third electrode is further formed in the dummy area.

6. The plasma display apparatus of claim 5, wherein the third electrode formed in the dummy area is not connected to the channel.

7. The plasma display apparatus of claim 1, wherein the data driver comprises:
a data driver integrated circuit for supplying a data signal to the third electrode with a switching operation; and
a flexible substrate in which the data driver integrated circuit is arrived and in which the channel is formed.

8. A plasma display apparatus comprising:
a plasma display panel comprising an electrode; and
a driver for supplying a driving signal to the electrode,
the plasma display panel comprises:
a front substrate;
a rear substrate opposite to the front substrate;
a barrier rib for partitioning a discharge cell between the front substrate and the rear substrate;
first electrodes and second electrodes opposite to each other in the discharge cell; and
third electrodes intersecting the first electrodes in the discharge cell,
wherein the number of the third electrodes is 4095 in an active area in which an image is displayed,
the driver comprises a plurality of data drivers comprising channels connected to the third electrodes, and
the data driver comprises a first data driver in which 192 channels are formed and a second data driver in which 256 channels are formed.

9. The plasma display apparatus of claim 8, wherein the number of the first data driver is 20 and the number of the second data driver is 1.

10. The plasma display apparatus of claim 8, wherein the discharge cell comprises a red color discharge cell, a green color discharge cell, and a blue color discharge cell, and
the number of each of the red color discharge cell, the green color discharge cell, and the blue color discharge cell is 1365.

11. The plasma display apparatus of claim 10, wherein the total number of the first electrodes is 768.

12. The plasma display apparatus of claim 8, wherein a dummy area is disposed at the outer side of the active area, and a part of the third electrode is disposed in the dummy area.

13. The plasma display apparatus of claim 12, wherein the third electrode disposed in the dummy area is not connected to the channel.

14. The plasma display apparatus of claim 8, wherein the data driver comprises:
a data driver integrated circuit for supplying a data signal to the third electrode with a switching operation; and
a flexible substrate in which the data driver integrated circuit is arrived and in which the channel is formed.
